(19) United States
(12) Patent Application Publication
(10) Pub. No.: US 2006/0282620 A1
(43) Pub. Date: Dec. 14, 2006

(54) Weighted LRU for associative caches

(76) Inventors: Sujatha Kashyap, Austin, TX (US); Mysore Sathyanarayana Srinivas, Austin, TX (US)

Correspondence Address: IBM CORP (YA);C/O YEE & ASSOCIATES PC, P.O. BOX 802333, DALLAS, TX, 75380, US

(21) Appl. No.: 11/152,557

(22) Filed: Jun. 14, 2005

(51) Int. Cl. G06F 12/00

(52) U.S. Cl. 711/128

(57) ABSTRACT

The present invention provides a method, system, and apparatus for communicating to associative cache which data is least important to keep. The method, system, and apparatus determine which cache line has the least important data so that this less important data is replaced before more important data. In a preferred embodiment, the method begins by determining the weight of each cache line within the cache. Then the cache line or lines with the lowest weight is determined.

### BACKGROUND OF THE INVENTION

1. Field of the Invention

The present invention is related to an improved data processing system. More specifically, the present invention relates to a method, system, and apparatus for communicating to associative cache which data is least important to keep.

2. Description of the Related Art

Memory bandwidth is a limiting factor with many modern microprocessors and it is usual to include a cache to reduce the amount of memory traffic. Caches are used to decrease average access times in CPU memory hierarchies, file systems, and so on. A cache is used to speed up data transfer and may be either temporary or permanent. Memory caches are in every computer to speed up instruction execution and data retrieval and updating. These temporary caches serve as staging areas, and their contents are constantly changing.

A memory cache, or “CPU cache,” is a memory bank that bridges main memory and the CPU. It is faster than main memory and allows instructions to be executed and data to be read and written at higher speed. Instructions and data are transferred from main memory to the cache in blocks, using some kind of look-ahead algorithm. The more sequential the instructions in the routine being executed or the more sequential the data being read or written, the greater chance the next required item will already be in the cache, resulting in better performance.

A level 1 (L1) cache is a memory bank built into the CPU chip or packaged within the same module as the chip. Also known as the “primary cache,” an L1 cache is the memory closest to the CPU. A level 2 cache (L2), also known as a “secondary cache”, is a secondary staging area that feeds the L1 cache. Increasing the size of the L2 cache may speed up some applications but have no effect on others. L2 may be built into the CPU chip, reside on a separate chip in a multichip package module or be a separate bank of chips on the motherboard. If the L2 cache is also contained on the CPU chip, then the external motherboard cache becomes an L3 cache. The L3 cache feeds the L2 cache, which feeds the L1 cache, which feeds the CPU. Caches are typically Static Random Access Memory (SRAM), while main memory is generally some variety of Dynamic Random Access Memory (DRAM).

Cache is accessed by comparing the address being referenced to the tag of each line in the cache. One way to do this is to directly compare the address of the reference to each tag in the cache. This is called a fully-associative cache. Fully-associative caches allow any line of data to go anywhere in the cache and data from any address can be stored in any cache location. The whole address must be used as the tag. All tags must be compared simultaneously (associatively) with the requested address and if one matches then its associated data is accessed. This requires an associative memory to hold the tags which makes this form of cache more expensive. It does however solve the problem of contention for cache locations (cache conflict) since a block need only be flushed when the whole cache is full and then the block to flush can be selected in a more efficient way. Therefore, Fully-associative cache yields high hit rates, but it is expensive in terms of overhead and hardware costs.

An alternative approach is to use some of the bits of the address to select the line in the cache that might contain the address being referenced. This is called a direct-mapped cache. Specifically, direct-mapped cache is where the cache location for a given address is determined from the middle address bits. Direct-mapped caches tend to have lower hit rates than fully-associative caches because each address can only go in one line in the cache. Two addresses that must go into the same line will conflict for that line and cause misses, even if every other line in the cache is empty. On the other hand, a direct-mapped cache will be much smaller than a fully-associative cache with the same capacity, and can generally be implemented with a lower access time. In a given amount of chip space, a direct-mapped cache can be implemented with higher capacity than a fully-associative cache. This may lead to the direct-mapped cache having a better hit rate than the fully-associative cache.

A compromise between these two approaches is a set-associative cache, in which some of the bits in the address are used to select a set of lines in the cache that may contain the address. The tag field of the address is then compared to the tag field of each of the lines in the set to determine if a hit has occurred. Set-associative caches tend to have higher hit rates than direct-mapped caches, but lower hit rates than fully-associative caches. They have lower access times than fully-associative caches, but slightly higher access times than direct-mapped caches. Set-associative caches are very common in modern systems because they provide a good compromise between speed, area, and hit rate. Performance studies have shown that it is generally more effective to increase the number of entries rather than associativity and that 2- to 16-way set associative caches perform almost as well as fully-associative caches at little extra cost over direct-mapped caches.

For the purposes of this disclosure the term “associative cache” encompasses both the terms fully-associative cache and set-associative cache.

Two of the most commonly used cache write-policies are the write-back approach and the write-through approach. The write-through approach means the data is written both into the cache and passed onto the next lower level in the memory hierarchy. The write-back approach means that data is initially only written to the L1 cache and only when a line that has been written to in the L1 cache is replaced is the data transferred to a lower level in the memory hierarchy.

The performance of both of these approaches can be further aided by the inclusion of a small buffer in the path of outgoing writes to the main memory, especially if this buffer is capable of forwarding its contents back into the main cache if they are needed again before they are emptied from the buffer. This is what is known as a victim cache.

The smallest retrievable unit of information in a cache is called a cache line. Since caches are much smaller than the total available main memory in a machine, there are often several different pieces of data (each residing at a different main memory address) competing for the same cache line. A popular approach for mapping data to cache lines is the use of a least recently used (LRU) based set associative caches. A hashing function, usually based on the real memory address of the data, is used to pick a set that the data will be put into. Once the set is chosen, a LRU policy determines in which of the cache lines in the set the new data will reside. The LRU policy puts the new data into the cache line that has not been referenced for the longest time.

The problem with this method is that the cache treats all data equally, without regard to program semantics. That is, critical operating system data is treated exactly the same as User X's music videos. The only indication a cache has of the relative importance of data is how recently (the data residing in) a cache line is accessed. Hence, a newly arriving piece of data, which is mapped into a set that contains both critical operating system data and Mr. X's music video files, is equally likely to displace either.

A prior solution to this problem is the use of a victim cache. However, victim caches try to keep discarded data around for future use rather than preventing the useful data from being displaced in the first place.

Therefore, it would be advantageous to provide a method, system, and computer software program product for communicating to associative cache which data is least important to keep.

### SUMMARY OF THE INVENTION

The present invention provides a method, system, and apparatus in a data processing system for communicating to associative cache which data is least important to keep. The method, system, and apparatus determine which cache line has the least important data so that this less important data is replaced before more important data. In a preferred embodiment, the method begins by determining the weight of each cache line within the cache. Then the cache line or lines with the lowest weight is determined.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the invention may be implemented;

FIG. 2 is a block diagram of a data processing system that may be implemented as a server in accordance with a preferred embodiment of the invention;

FIG. 3 is a block diagram of a typical page table entry;

FIG. 4 is a block diagram of a page table entry modified in accordance with the present invention;

FIG. 5a shows a typical cache subsystem;

FIG. 5b shows an illustrative entry in the tag table in accordance with a preferred embodiment of the present invention; and

FIG. 6 is a flowchart that shows the sequence of actions that occur when a data reference is issued by the processor, in accordance with a preferred embodiment of the present invention.

### DETAINED DESCRIPTION OF THE PREFERRED EMBODIMENT

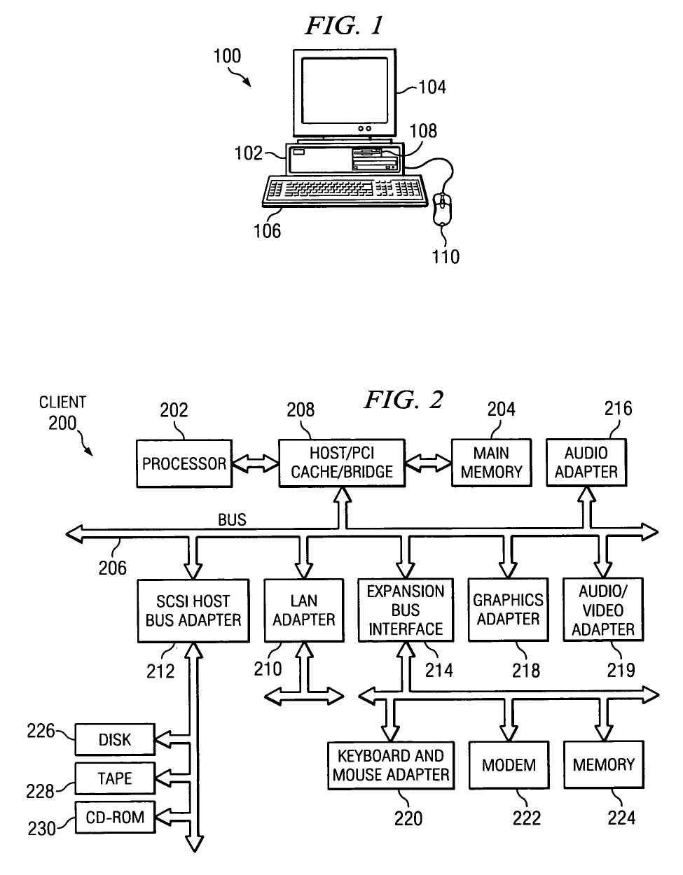

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 includes some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention provides a new cache replacement policy for associative caches, to be used in lieu of simple LRU. A weight is associated with each piece of data, by software. A higher weight indicates greater importance. There are various ways in which this association could be achieved, and various entities that could be involved in establishing such a mapping. The present invention is not restricted to any specific means of choosing the mapping between a piece of data and the weight assigned to it.

There are several ways in which such a mapping could be established. For example, the operating system could associate a pre-assigned weight to each type of data. For example, per-process private data could be assigned a weight of 1, shared library text could be assigned a weight of 2, critical operating system data structures could be assigned a weight of 3 etc. Or, the operating system could expose an interface to users of the system, by which a user could assign higher weights to more crucial applications, so that they receive preferential treatment in the hardware cache. These two approaches could even be used in combination, where an operating system assigns different default weights to different kinds of data, and a user can override some of these defaults through system calls. Furthermore, this mapping can be done at the granularity of a page, or a segment. That is, either all the bytes in a page can have the same weight, or all the bytes in a segment can have the same weight. Other granularities are also possible.

Once the weight of each piece of data has been established, a way is needed to make this information available to the cache at the time when new data is brought into the cache. If the weight is assigned at a page level, an additional field could be added to each hardware page table entry that contains the weight of the page. If the weight is assigned on a segment level, then the segment table entries could be augmented by a field that contains the weight of the segment.

The present invention is independent of the mechanism used to make the cache aware of the weight of a particular piece of data. The only requirement is that, when data is first brought into the cache from main memory, the cache should be able to access the weight associated with that data.

The weight associated to the data by software becomes the initial weight of the corresponding cache line when the data is first brought into the cache. In one possible embodiment, each time this cache line is referenced, the weight of the data is incremented by a constant amount, such as 1, for example. Thus, over time, a frequently used cache line with an initial weight of 2 could catch up in importance to a never-referenced cache line with an initial weight of 4. Therefore, an additional field needs to be added to each cache line, which stores the current weight of the cache line.

In order to avoid infinitely incrementing the weight of a cache line, a limit can be placed on the maximum weight a cache line can have. Thus, if a cache line is referenced a lot, then its weight will increase upon each reference until it reaches the predefined maximum weight. Each reference thereafter will have no effect on the weight of the line.

In another illustrative embodiment, a binary tree indicates a lower weighting. The binary tree indicates for each node whether that node's right or left child has a lower weight. Upon each cache reference, the weight of the reference line is increased by one and the binary tree is updated to reflect the new balance of weights. The weighted binary tree functions as a regular binary search tree. An incoming cache line traverses the binary tree by choosing a child node with the lesser weight at each level and replaces the cache line with the least weight.

When new data is brought into cache, it is first mapped to a set in the cache (just like in any usual associative cache). Once the set is chosen, the cache line with the least weight in that set is chosen for replacement. If more than one cache line has the same (least) weight, then the least recently used cache line out of these is chosen for replacement. The new data is placed into the chosen cache line, and the weight field of this cache line is set (re-initialized) to the initial weight of the new data occupying it.

It is important to note that while the above detailed invention has been described in terms of cache, in a preferred embodiment, the above detailed invention is implemented in hardware cache.

The primary advantage of the present invention is to provide a means for making cache line replacement decisions based on some measure of the importance of the data occupying the cache lines. The approach described above is highly adaptive—it constantly compromises between frequency of reuse and the “importance” of incoming data. Simply put, cache lines age over time, with more important cache lines “expiring” later than less important cache lines.

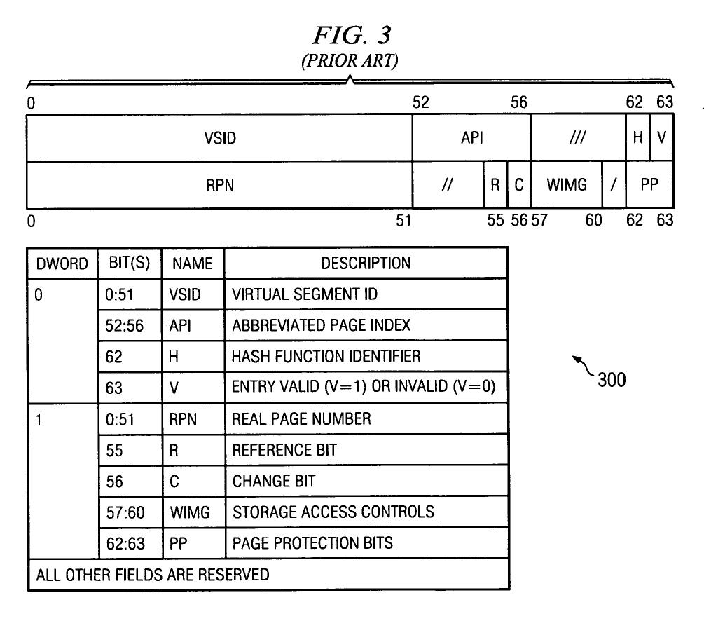

With reference now to FIG. 3, a block diagram of a typical page table entry is shown. Page Table Entry (PTE) 300 is a typical PTE of the PowerPC platform. PTE 300 shows the first 63 bits of the PTE. In the case of Dword 0, bits 0 through 51 are the virtual segment ID (VSID), bits 52 through 56 is the abbreviated page index (API), bit 62 is the hash function indicator (H), and bit 63 indicates whether or not the entry is valid (V), V equals 1, or invalid, V equals 0. For Dword 1, bits 0 through 51 are the real page number (RPN), bit 55 is the reference (R) bit, bit 56 is the change (C) bit, bits 57 through 60 are the storage access controls (WIMG), and bits 62 and 63 are the page protection (PP) bits. All other fields in the PTE are reserved.

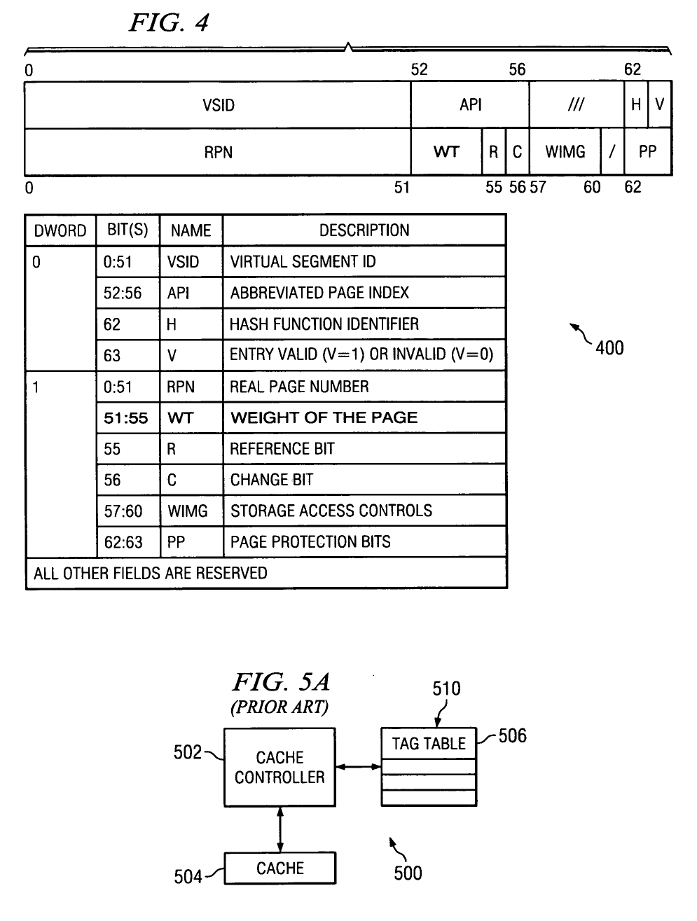

FIG. 4 is a block diagram of a page table entry in accordance with the present invention. Page Table Entry (PTE) 400 is a typical PTE of the PowerPC platform, modified in accordance with the present invention. PTE 400 shows the first 63 bits of the PTE. In the case of Dword 0, bits 0 through 51 are the VSID bits, bits 52 through 56 are the API bits, bit 62 is the H bit, and bit 63 is the V bit. For Dword 1, bits 0 through 51 are the RPN bits, bits 51 through 55 are the weight of the page (WT), bit 55 is the R bit, bit 56 is the C bit, bits 57 through 60 are the WIMG bits, and bits 62 and 63 are the PP bits. All other fields in the PTE are reserved.

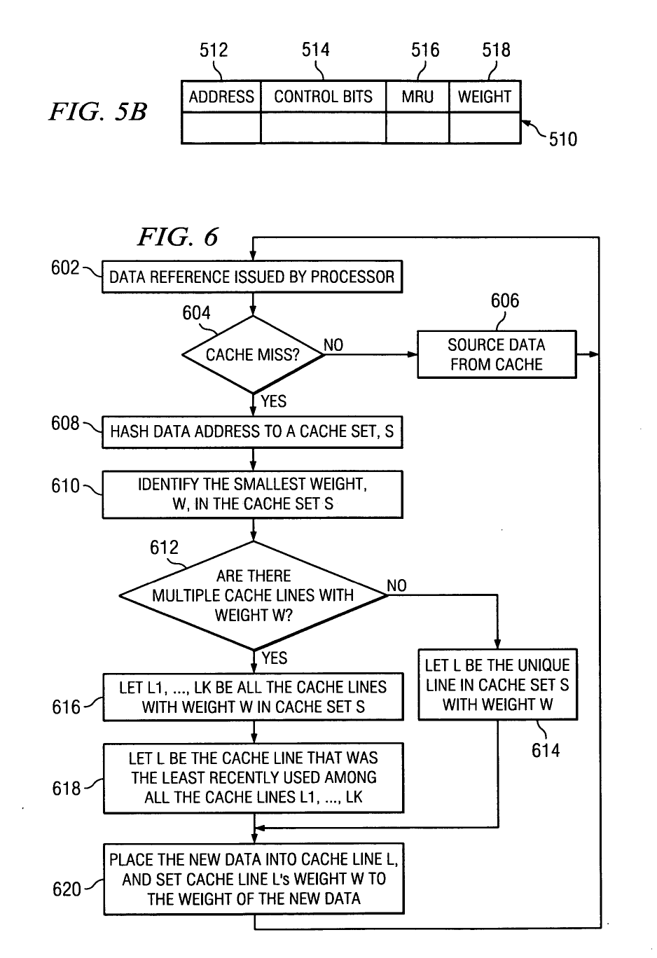

FIG. 5a shows a typical cache subsystem. In cache subsystem 500, cache controller 502 controls access to cache 504 and implements the cache replacement algorithm to update the cache. Tag table 506 contains information regarding the memory address of the data contained in the cache, as well as control bits. Referring to FIG. 5b, an illustrative entry in the tag table in accordance with a preferred embodiment of the present invention is shown. Tag table entry 510 is one entry of a tag table, such as tag table 506 in FIG. 5a. One tag table entry is provided for each line in cache 504. Tag table entry 510 includes address 512, control bits 514, most recently used (MRU) 516 and weight 518. MRU 516 is set when the cache at that particular line is accessed. MRU 516 is utilized in the LRU replacement algorithm implemented by cache controller 502. The present invention adds an extra field, weight 518, to a typical tag table entry. Weight 518 contains the weight of the data currently residing in the cache line. Address 512 is used to determine when a cache hit has occurred. When a cache miss occurs, cache controller 502 uses weight 518 to determine which cache line to replace, as illustrated in the flowchart of FIG. 6.

FIG. 6 is a flowchart that shows the sequence of actions that occur when a data reference is issued by the processor, in accordance with a preferred embodiment of the present invention. The method is designated by reference number 600 and begins when a data reference is issued by a processor (step 602). A determination is made as to whether or not a cache miss occurs (step 604). If a cache miss does not occur (a no output from step 604), source data is retrieved from cache (step 606) and the method waits for a new data reference to be issued (step 602).

If a cache miss does occur (a yes output from step 604), then the data address is hashed to cache set S (step 608). Next, identify the smallest weight, W, in cache set S (step 610). Determine if there are multiple cache lines with weight W (step 612). If there are not multiple cache lines with weight W (a no output from step 612), then let L be the unique line in cache set S with weight W (step 614). Proceed from step 620.

If there are multiple cache lines with weight W (a yes output from step 612), then let L1 through Lk be all the cache lines with weight W in cache set S (step 616). Let L be the cache line that is the least recently used among all the cache lines L1 through Lk (step 618). Place the new data into cache line L and set cache line L's weight, W, to the weight of the new data (step 620) and wait for the next data reference issued by the processor, repeat step 602.

The primary advantage of the present invention is to provide a means for making cache line replacement decisions based on some measure of the importance of the data occupying the cache lines. The approach described above is highly adaptive—it constantly compromises between frequency of reuse and the “importance” of incoming data. Simply put, cache lines age over time, with more important cache lines “expiring” later than less important cache lines.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system for communicating to associative cache which data, among data stored in the cache, is least important to keep, the method comprising:
storing a non-zero weight of each cache line of data of a plurality of cache lines in a data structure;
retrieving the non-zero weight of each cache line of data of a plurality of cache lines from the data structure; and
determining a sub-set of cache lines with a lowest weight.

2. The method of claim 1, wherein the step of determining a sub-set of cache lines with a lowest weight includes traversing a binary tree wherein each node of the binary tree represents a cache line of data and wherein a non-zero weight is associated with each node of the binary tree.

3. The method of claim 2, wherein traversing a binary tree includes beginning at a root node, selecting a child node having a lesser weight and repeating the selection from the selected child node until an end node is encountered.

4. The method of claim 1, wherein the data structure is a tag table entry.

5. The method of claim 4, wherein the tag table entry includes of an extra field added to the tag table entry in addition to existing tag fields, wherein the extra field contains the non-zero weight of the cache line of data.

6. The method of claim 1, further includes:
increasing the non-zero weight of a cache line of data every time the cache line of data is accessed.

7. The method of claim 1, wherein the non-zero weight of each cache line of data of the plurality of cache lines is determined by the importance of the data contained in the cache line of data.

8. The method of claim 1, further includes:
assigning the non-zero weight of a cache line of data to the cache line of data by at least one of an operating system or a user.

9. A computer program product comprising:
a computer usable medium including computer usable program code for communicating to associative cache which data, among data stored in the cache, is least important to keep, said computer program product including:
computer usable program code for storing a non-zero weight of each cache line of data of a plurality of cache lines in a data structure;
computer usable program code for retrieving the non-zero weight of each cache line of data of a plurality of cache lines from the data structure; and
computer usable program code for determining a sub-set of cache lines with a lowest weight.

10. The computer program product of claim 9, wherein the computer usable program code for determining a sub-set of cache lines with a lowest weight includes computer useable program code for traversing a binary tree wherein each node of the binary tree represents a cache line of data and wherein a non-zero weight is associated with each node of the binary tree.

11. The computer program product of claim 10, wherein the computer useable program code for traversing a binary tree includes computer useable program code for beginning at a root node, selecting a child node having a lesser weight and repeating the selection from the selected child node until an end node is encountered.

12. The computer program product of claim 9, wherein the data structure is a tag table.

13. The computer program product of claim 12, wherein the tag table entry includes of an extra field added to the tag table entry in addition to existing tag fields, wherein the extra field contains the non-zero weight of the cache line of data.

14. The computer program product of claim 9, wherein the non-zero weight of each cache line of data of the plurality of cache lines is determined by the importance of the data contained in the cache line of data.

15. The computer program product of claim 9, further includes:
computer usable program code for assigning the non-zero weight of a cache line of data to the cache line of data by at least one of an operating system or a user.

16. A data processing system for communicating to associative cache which data, among data stored in the cache, is least important to keep, the data processing system comprising:
a tag table that stores a non-zero weight of each cache line of data of a plurality of cache lines;
an operating system component that retrieves the non-zero weight of each cache line of data of a plurality of cache lines from the data structure; and
an operating system component that determines a sub-set of cache lines with a lowest weight.

17. The data processing system of claim 16, wherein the data structure is a tag table entry.

18. The data processing system of claim 17, wherein the tag table entry includes of an extra field added to the tag table entry in addition to existing tag fields, wherein the extra field contains the non-zero weight of the cache line of data.

19. The data processing system of claim 16, further includes:
An operating system component that increases the non-zero weight of a cache line of data every time the cache line of data is accessed.

20. The data processing system of claim 16, further includes:
assigning the non-zero weight of a cache line of data to the cache line of data by at least one of an operating system or a user.
